(19) United States
(12) Patent Application Publication
(10) Pub. No.: US 2018/0050939 A1
(43) Pub. Date: Feb. 22, 2018

(54) Super Oxide Water Treatment

(71) Applicant: Noles Intellectual Properties, LLC, Washington, OK (US)

(72) Inventor: Jerry W. Noles, JR., Blanchard, OK (US)

(73) Assignee: Noles Intellectual Properties, LLC, Washington, OK (US)

(21) Appl. No.: 15/243,157

(22) Filed: Aug. 22, 2016

(51) Int. Cl. C02F 1/72; B01D 53/02; E21B 43/34

(52) U.S. Cl. CPC C02F 1/727; C02F 2101/203; E21B 43/34; B01D 53/02

(57) ABSTRACT

Systems and methods for water treatment include a method that may comprise pumping a produced water from an individual well to a central storage reservoir; removing nitrogen from an air mass, with a molecular sieve, to provide O₂; directing the O₂ through an ion exchange bed, thereby converting the O₂ to O₂⁻; and injecting the O₂⁻ into the produced water.

### BACKGROUND

Within recent years, the oil and gas industry has developed the use of hydraulic fracturing to produce what was once considered nonproductive oil and gas formations. This hydraulic fracturing technology may use high volumes of water to be pumped into the wells under tremendous rates and pressures to pry subterranean rock apart, thereby allowing the oil and gas that is trapped within the matrix of these formations to migrate to the wellbore and production casing. Although the use of this technology may have allowed high volumes of oil and gas recovery from these formations, the use of these large volumes of water has been widely scrutinized. The water that is used during these fracturing operations is typically clarified and free from contaminates and bacteria. Therefore, the current technologies may use fresh water sources that may be normally used for irrigation and human consumption. Recent droughts have limited availability of these fresh water supplies for human consumption and irrigation. Although the fracturing (“frac”) water may be recovered over the production life of the oil and gas well, the water may become contaminated with chemicals from the fracturing process along with salts and minerals that may be leached from the producing reservoir during the production of the well. Most oil and gas reservoirs may have been created from decomposed organic matter generated from an oceanic seabed. This fresh water may mix with the salt water that may typically be produced from the hydrocarbon formations, making both the frac water and the formation water unsuitable for human consumption or reuse for hydraulic fracturing.

This water that may be produced or that may flow back from the well may then be disposed of by pumping it into deep nonproductive oil and gas formations. Recently, this produced water injection process may have been blamed for elevations in seismic activity in many regions of Oklahoma and Texas. This cycle may be repeated for each well and may use hundreds of thousands of barrels of water for each operation. This process and reduced fresh water supplies may have generated a need for an economic technology that may clean these large volumes of water generated by the flow-back and production of these wells to allow the water to be reused instead of disposed, thereby reducing the burden that is placed on fresh water supplies.

The industry has tried multiple technologies to clean and repurpose this water and although somewhat successful, in certain areas the complexity of the water from area to area and even well to well, has made it difficult for companies to provide a stable solution that can address these wide variations of water conditions. The technology must be capable of handling high volumes of suspended solids such as polymers and chemicals, as well as the smaller dissolved solids such as, for example, iron, salts, and other minerals.

This wide range in particle size and volume of solids has made handling this material difficult. Although technologies, such as, for example, reverse osmosis membrane systems or molecular filters have been used to separate these small particles from the water, they may not be designed to handle high levels of solids or chlorides. This may further be compounded by the nature of very small droplets of oil being entrained within the body of the water. This oil that coexists within this produced water may be up to five percent by volume and may cause these membranes to degrade and fail.

The industry has often been left with using methods that were developed for wastewater treatment of municipals. These technologies may use large capacity retention ponds and polymers, along with microbes to digest and separate the solids from the water. And although this technology may have worked for years in the municipal areas, it was never designed to handle the types of materials associated with produced oil and gas water.

Recently, various new technologies may have been introduced into the oil and gas industry that may have proven that the use of oxidation processes can be effective when used to treat and clarify produced water making it acceptable for the use in the fracturing process or ready for further processing. These technologies include micro bubble aeration systems, ozone, chlorine dioxide and hydrogen peroxide. A challenge with the use of any oxidation process may be calculating the amount of oxygen that the water can absorb and the reactivity of the oxidizer that is placed into the water. The stronger the oxidizer, the faster the reaction process may be, and the more corrosive and volatile the handling process may become. Although the use of these highly reactive oxidizers in large volumes may have proven effective in treating water, they may be a less preferred method from a health, safety and environmental position.

This may be further complicated due to the fact that produced water may be unique in the aspect that it may possess high levels of iron and other material that may elevate the Chemical Oxidation Demand (“COD”) requirements. This may require substantially higher levels of oxidizer per unit of volume than a municipality operation that has a high Biological Oxidation Demand (“BOD”) requirement. It is this high COD requirement that may have prevented the use of on demand oxidation processes that may be less reactive, such as ozone, or chlorine generation, from being effective. This combined with scaling issues caused by an anode and a cathode coming into direct contact with a water that has high amounts of salts and minerals, such as, for example, calcium carbonate, may have made on demand oxidation processes ineffective. Therefore, there exists a need for an effective and less volatile oxidation process.

### BRIEF DESCRIPTION OF THE DRAWINGS

These drawings illustrate certain aspects of some of the embodiments of the present disclosure and should not be used to limit or define the disclosure.

FIG. 1 illustrates a water treatment system in accordance with embodiments of the present disclosure.

### DETAILED DESCRIPTION

The present disclosure may generally relate to a treatment of water by oxidation, and may effectively be applied to water storage basins (e.g., tanks, pits) and may not be impacted or fouled by scaling issues generated from direct contact on-demand chemical production. Additionally, the present disclosure may provide an ecologically sound and cost effective solution for removing contaminants from a water source without introducing pollutants or chemical additives, and may increase dissolved oxygen levels in the water (i.e., oxidation).

Aerobic microbes may be energized by increased oxygen levels, stimulating growth and reproduction. The microbes may eliminate organic pollutants in a body of water by feeding on carbon particulates that may be released during an oxidation process. Applications of the present disclosure may include industrial and agricultural run-off problems, blue green algae infestation, well fracking (e.g., clean-up of waste water), emergency oil spills, general water cleaning for harbors and marinas, municipal utilities (e.g., emergency and community clean-up), retention pond clean-up (e.g., golf courses, parks), and aquariums and zoos.

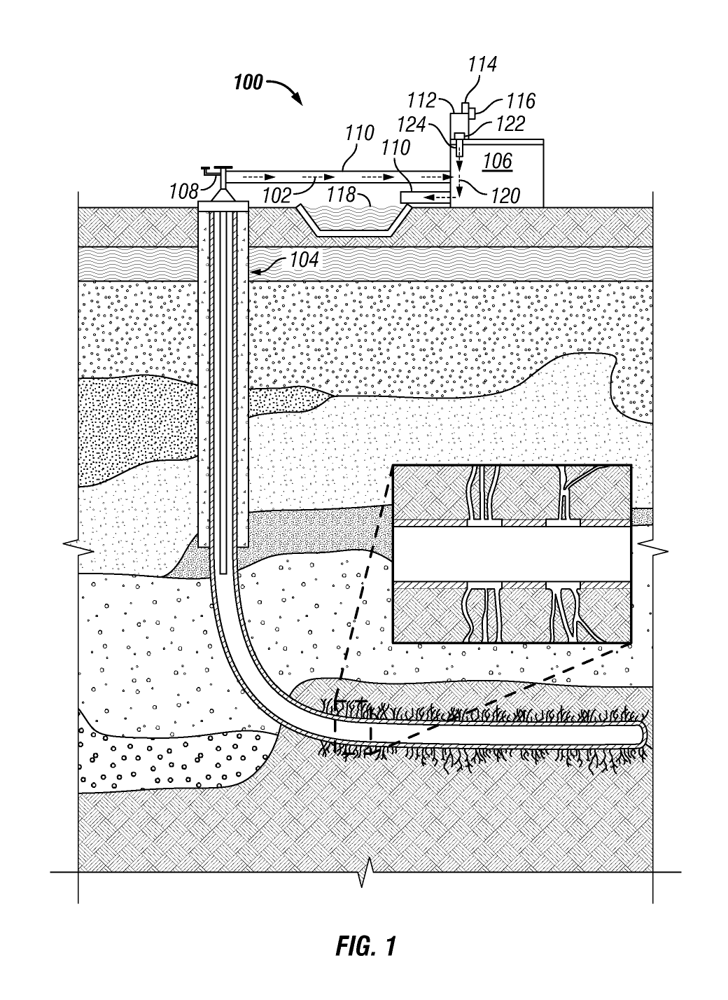

FIG. 1 illustrates a water treatment system 100, wherein flow back or produced water 102 may be pumped from an individual well 104 (or a plurality of wells 104) to a central storage reservoir 106 via a pump 108 and piping 110. The pump may be any suitable type of pump, such as, without limitation, a high volume low pressure pump. The storage reservoir 106 may be any suitable type of storage, such as, without limitation, a steel tank. The central storage reservoir 106 may include an on-demand oxygen generator 112 which may include a molecular sieve 114 and an ion exchange bed 116.

Molecular sieve 114 may remove nitrogen from an air mass (e.g., air mass surrounding the central storage reservoir 106). Molecular sieve 114 may include a macroporous material, a mesoporous material and/or a macroporous material. The pore diameters may include dimensions of small molecules, thus large molecules may not be absorbed, while smaller molecules may be absorbed. Microporous materials may have pore diameters of less than about 2 nm, mesoporous materials may have pore diameters between about 2 nm and about 50 nm, and macroporous materials may have pore diameters of greater than about 50 nm.

The on-demand oxygen generator 112 may generate at least about 98 wt. % pure oxygen by removing the nitrogen from the air mass with molecular sieve 114. The air mass may have any oxygen and nitrogen content. In embodiments, an air mass may be about 21 wt. % oxygen and about 78 wt. % nitrogen, along with a small percentage of other gases. The on-demand oxygen generator 112 may include any oxygen generator suitable for increasing the oxygen content of an air mass. The generated O₂ may then be pushed/directed from the molecular sieve 114 through an ion exchange bed 116, where the O₂ may pick up a negative ion, thereby converting the O₂ to an O₂⁻ (Super Oxide 120). Ion exchange bed 116 may include an insoluble matrix (or support structure) which may be in the form of beads which may be fabricated from an organic polymer substrate. The beads may contain resin and be typically porous, providing a high surface area. The beads may have any suitable diameter, such as, for example, from about 0.5 mm to about 1.0 mm. The beads may comprise any suitable porous material. In an embodiment, the beads may comprise an organic polymer substrate. It is to be understood that the insoluble matrix is not limited to beads, but may include another suitable configuration such as pellets, balls, and the like. The organic polymer substrate may include polystyrene sulfonate, styrene-divinylbenzene, methacrylic-divinylbenzene, phenol polymers, formaldehyde polymers, polymers produced from hydroquinone or any combinations thereof. The trapping of ions may occur with the accompanying releasing of other ions; thus, the process may be called ion-exchange. Ion-exchange resins may be used in different separation, purification, and decontamination processes, such as, for example, water softening and water purification/treatment. The ion-exchange resins may be introduced in such processes as an alternative to the use of natural or artificial zeolites. Also, ion exchange resins may be highly effective in a biodiesel filtration process.

By adding the negative ion to the O₂, the O₂⁻ (Super Oxide 120) may become more soluble in water (e.g., produced water 102). The addition of the negative ion to the O₂ may increase an amount of anatomic oxygen absorbed into the produced water 102 over standard aeration processes by a factor of 20. This accelerated absorption may allow a higher BOD and COD to be met. BOD may be the amount of dissolved oxygen needed (demanded) by aerobic biological organisms to break down organic material present in a produced water 102 sample at a certain temperature over a specific time period. The BOD value may be expressed in milligrams of oxygen consumed per liter of a produced water 102 sample during 5 days of incubation at 20° C. and may often be used as a surrogate of the degree of organic pollution of produced water 102. BOD may be used as a gauge of the effectiveness of wastewater treatment plants. BOD may be similar in function to COD, in that both may measure the amount of organic compounds in produced water 102. However, COD may be less specific, since it may measure everything that can be chemically oxidized, rather than just levels of biodegradable organic matter. A COD test may be used to indirectly measure an amount of organic compounds in water. Applications of COD may determine an amount of organic pollutants found in surface water (e.g., lakes, rivers) or wastewater, making COD a useful measure of water quality. It may be expressed in milligrams per liter, which may indicate the mass of oxygen consumed per liter of solution.

In oilfield produced water (e.g., produced water 102), it may be difficult to impart enough oxidizer (e.g., Super Oxide 120) into the produced water 102 to feed the higher COD requirements caused from the high levels of iron sulfide and other contaminants within the produced water 102. By generating the Super Oxide 120, over 90% of the pure O₂ may be absorbed into the produced water 102, thereby rapidly accelerating the chemical oxygen demand and reducing residence time and pit volume (e.g., volume for pit 118). Without limitation, such absorption may be dependent upon the ionic strength of the water. Pit 118 (or a plurality of pits 118) may be used to store produced water 102. This may mean that more produced water 102 may be cleaned/treated at a faster rate with on-demand oxidizer generation than without on-demand oxidizer generation. This may have a substantial impact in the oil and gas industry by reducing cost while improving operational retention times to react with the produced water 102.

Referring back to FIG. 1, the produced water 102 may be brought into a water treatment system 100 which may be located in relative proximity of the developmental drilling and fracturing sites (e.g., well 104), the produced water 102 may be measured and tested using a variety of procedures, such as, for example, pH testing, oxidative reduction potential testing, conductivity and resistivity testing, dissolved oxygen testing, and turbidity and temperature testing. The produced water 102 may be piped (e.g., piping 110) into the pit 118 and/or storage reservoir 106, the Super Oxide 120 may be added to the produced water 102 at a section of the storage reservoir 106 where the produced water 102 exits the storage reservoir 106 and enters into the pit 118, with the flow passing from one end of the pit 118 to an opposite end, thereby allowing sufficient residence time for the Super Oxide 120 to treat the produced water 102. The residence time may be from about 5 minutes to about 1 hour. The Super Oxide 120 may convert soluble Fe (II) in the produced water 102 to its insoluble form, Fe (III), thus, allowing the iron to be more readily removed by gravitational settling means. In an embodiment, at least 90% of the iron may be converted from Fe (II) to Fe (III). Alternatively, at least about 99% of the iron may be converted from Fe (II) to Fe (III).

In certain embodiments, treatment water system 100 may not include pit 118, thus, treatment of produced water 102 with Super Oxide 120 may take place in storage reservoir 106. The Super Oxide 120 may be added to the produced water 102 at a section of the storage reservoir 106 where produced water 102 enters into the storage reservoir from piping 110, with the flow passing from one end of the storage reservoir 106 to an opposite end, thereby allowing sufficient residence time for the Super Oxide 120 to treat the produced water 102. The Super Oxide 120 may convert soluble Fe (II) in the produced water 102 to its insoluble form, Fe (III), thus, allowing the iron to be more readily removed by gravitational settling means. In an embodiment, at least 90% of the iron may be converted from Fe (II) to Fe (III). Alternatively, at least about 99% of the iron may be converted from Fe (II) to Fe (III).

The treatment of produced water 102 with Super Oxide 120 (oxidation process) also may aid in destroying bacteria and dissolved solids, such as, for example, organic pollutants, and reducing toxicity levels. The oxidation process may additionally break down hydrocarbons and sludge by volumetrically reducing these elements during the treatment process and may remove organic pollutants in the body of produced water 102, such as, for example, hydrocarbons, ammonia, nitrates, nitrites, phosphates, and oil dispersants. The oxidation process may also remove anaerobic bacteria, such as, for example, colon bacillus and cholera, and may increase oxygen solubility (e.g., BOD and COD) and increase a growth of aerobic bacteria and plankton and increase marine ecology by removing elements that inhibit a healthy body of water. The oxidation process may be operated in fresh or salt water and may increase the dissolved oxygen in the water by up to about 20 parts per million (“ppm”) to about 25 ppm, alternatively, from about 0.1 ppm to about 10 ppm, and, alternatively, from about 0 ppm to about 10 ppm. The oxidation process may produce a large amount of hydroxyl free radicals and may not only destroy and convert many of the dissolved solids, but the oxidation process may cause a reduction in the density of the produced water 102, thereby helping small droplets of oil that are contained within the produced water 102 to separate away from the main body of the produced water 102. By accelerating the oxidation process through the use of the Super Oxide 120, the number and size of retention tanks (e.g., storage reservoir 106) may be substantially reduced over conventional water treatment. Super Oxide 120 may stay longer in solution, thereby reducing the need for continuous re-treatment of the produced water 102 to maintain bacterial control. Without limitation, the time that Super Oxide 120 may stay in solution may be dependent upon water ionic strength, biological oxygen demand and chemical oxygen demand, water temperature, and/or barometric. This may be important when it comes to oilfield produced water (e.g., produced water 102), due to the fact that many of the biocides currently used may be poisonous and carcinogenic.

In certain embodiments, the Super Oxide 120 may be introduced into the produced water 102 through piping 110, which may be pressurized or configured to increase the atmospheric pressure that the produced water 102 is in, and to assist in preventing the Super Oxide 120 from vaporizing out of the produced water 102, thereby making the Super Oxide 120 more effective and enabling the Super Oxide 120 longer contact time with elements within the produced water 102. The Super Oxide 120 may be introduced into an elevated pressure conduit (e.g., piping 110) of about 10 psi to about 50 psi, and, alternatively, above about 50 psi. This elevated pressure may further prevent H₂S from vaporizing out of the produced water 102, thereby enabling the Super Oxide 120 to contact and destroy the H₂S before it can reach a gaseous state. Further, without limitation, the elevated pressure may prevent all dissolved gases from liberating from the water, thus creating a more efficient conversion of Fe (II) to Fe (III), as well as, a more efficient destruction of the H₂S molecule.

The pressurized/compressed Super Oxide 120 may be injected (e.g., via a pump 122 and nozzle 124 fluidly coupled to the on-demand oxygen generator 112) into the produced water 102 thereby creating bubbles to allow for absorption of Super Oxide 120 into the produced water 102. Organic pollutants may have carbon atoms that may be positively charged. Without limitation, the negatively charged oxygen atoms of Super Oxide 120 may attract the carbon atoms and pull them away from the pollutant molecules. When a positively charged carbon atom is met by two oxygen atoms (e.g., O₂⁻), the carbon atom may be pulled from the hydrogen atoms and may reformulate with the oxygen atom. The result may be the release of two harmless gasses, such as, for example, hydrogen and carbon dioxide. The interfacial surface tension of the fluid moving through the piping 110 may assist in mixing and normalizing the Super Oxide 120 with the produced water 102. The interfacial surface tension of the water passing through the piping 110 may help to normalize the Super Oxide 120, and may be variable depending on the flow rate and diameter of piping 110.

The treated water in the pit 118 and/or storage reservoir 106 may now suitable for further desalination with the use of a reverse osmosis membrane for drinking purposes or may be directed straight to additional fracturing operations or transported offsite. This system may be scalable and may require low energy and may generate high volumetric through-puts.

It is believed that the operation and construction of the present disclosure will be apparent from the foregoing description. While the apparatus and methods shown or described above have been characterized as being preferred, various changes and modifications may be made therein without departing from the spirit and scope of the disclosure as defined in the following claims.

What is claimed is:

1. A method for treating produced water, the method comprising:
pumping the produced water from an individual well to a central storage reservoir;
removing nitrogen from an air mass to provide O₂;
directing the O₂ through an ion exchange bed, thereby converting the O₂ to 02⁻; and
introducing the O₂⁻ into the produced water.

2. The method of claim 1, further comprising pressurizing the produced water.

3. The method of claim 2, further comprising preventing pollutants from vaporizing out of the produced water.

4. The method of claim 3, wherein the pollutants comprise H₂S.

5. The method of claim 1, wherein the introducing comprises creating bubbles to allow for absorption of the O₂⁻ into the produced water.

6. The method of claim 1, wherein over 90% of the O₂⁻ is absorbed into the produced water.

7. The method of claim 1, wherein the O₂ is at least about 98 wt. % oxygen.

8. The method of claim 1, wherein removing the nitrogen is accomplished with a molecular sieve.

9. The method of claim 1, further comprising releasing hydrogen and carbon dioxide.

10. The method of claim 1, further comprising converting soluble iron to insoluble iron.

11. The method of claim 10, further comprising removing the insoluble iron by gravitational settling.

12. The method of claim 1, further comprising increasing dissolved oxygen in the produced water up to about 20 ppm to about 25 ppm.

13. A system for treating produced water, the system comprising:
a central storage reservoir, wherein the central storage reservoir comprises:
an on-demand oxygen generator; and
an ion exchange bed;
a pit configured to store the produced water.

14. The system of claim 13, further comprising pressure piping coupled to the central storage reservoir, wherein the pressure piping comprises produced water.

15. The system of claim 14, wherein the pressure piping is configured to increase atmospheric pressure.

16. The system of claim 13, wherein the ion exchange bed is configured to convert O₂ to O₂⁻.

17. The system of claim 16, wherein the O₂ is configured to convert insoluble iron to soluble iron.

18. The system of claim 13, wherein the on-demand oxygen generator comprises a molecular sieve.

19. The system of claim 18, wherein the molecular sieve is configured to remove nitrogen from an air mass to provide the air mass with at least about 98 wt. % oxygen.

20. The system of claim 13, wherein the on-demand oxygen generator comprises a nozzle configured to inject O₂⁻.
